(19) United States
(12) Patent Application Publication
(10) Pub. No.: US 2026/0207006 A1
(43) Pub. Date: Jul. 23, 2026

(54) CampBuddy

(71) Applicants: Chambala Jabez El-Amin Hollis, Phoenix, AZ (US); Orlando Roy Gaddy, SR., Ravenna, OH (US)

(72) Inventors: Chambala Jabez El-Amin Hollis, Phoenix, AZ (US); Orlando Roy Gaddy, SR., Ravenna, OH (US)

(21) Appl. No.: 19/029,626

(22) Filed: Jan. 17, 2025

(51) Int. Cl. A47J 37/07

(52) U.S. Cl. CPC A47J 37/0763

(57) ABSTRACT

CampBuddy is a lightweight portable mini BBQ grill that was invented by using a 1 gallon paint can, equipped with three metal handles, one temperature gauge, four legs made of screws that serve as stands and small door hinges to open/close the lid. The color is; Flat BBQ Black “High Heat” which resist up to 1200° degrees Fahrenheit. The heat plate supports the aluminum foil charcoal/sterno tray.

### BRIEF DESCRIPTION OF FIGURES

FIG. 1 DW-001—Assembly Left to Right—Line 1 Left side view, Ariel, Front Left to Right—Line 2 Back view, Color Rendering view, Bottom view.

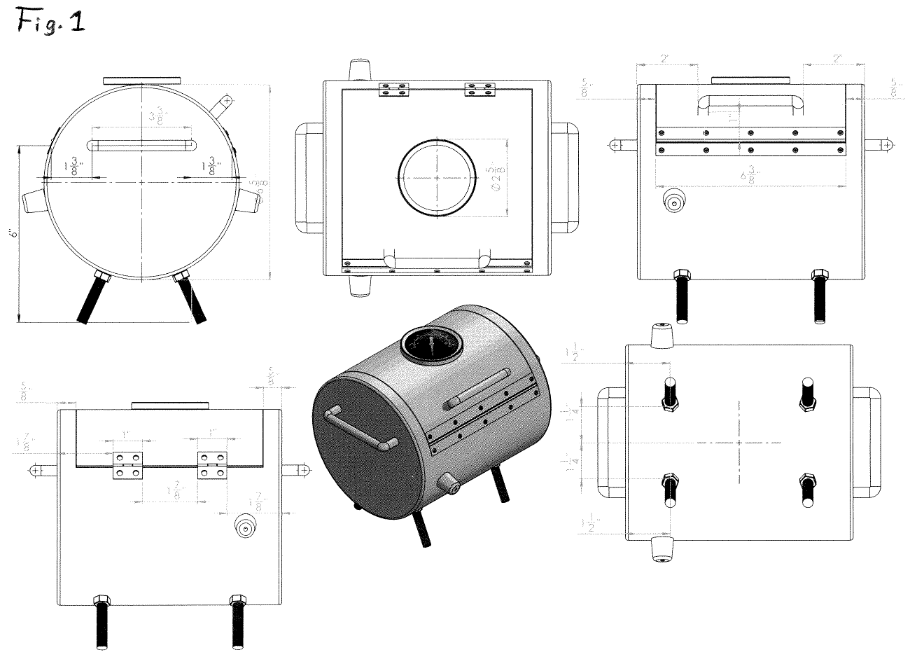

FIG. 2 DW002—Colored view.

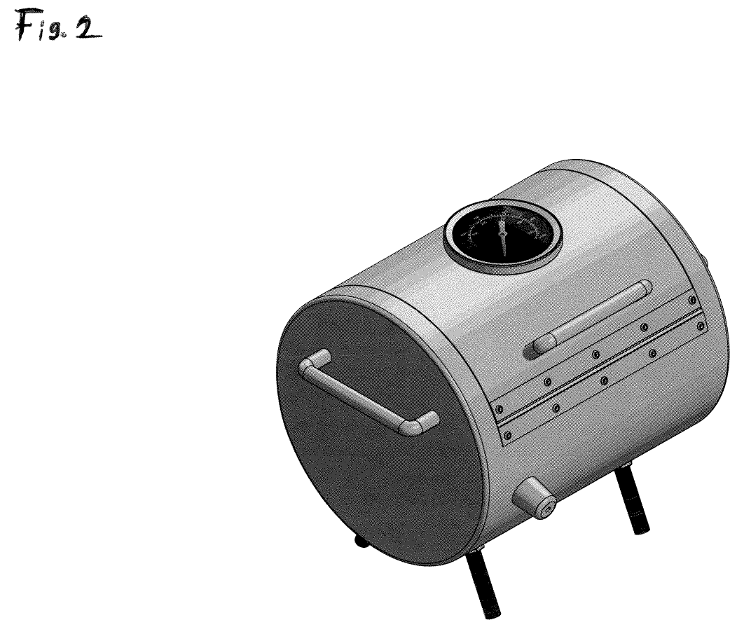

FIG. 3 DW-003 Back view with hinges and temperature gauge on top and stands-legs-screws on bottom.

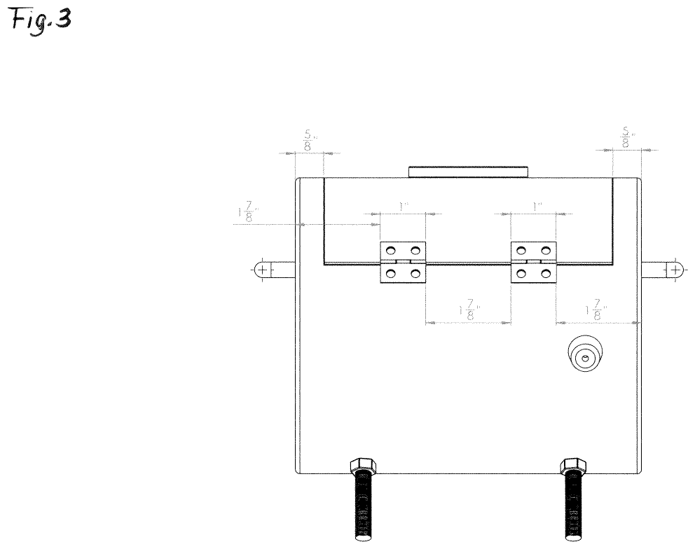

FIG. 4 DW-004 Front view with lid flashing—10 rivets and front stand-legs-screws.

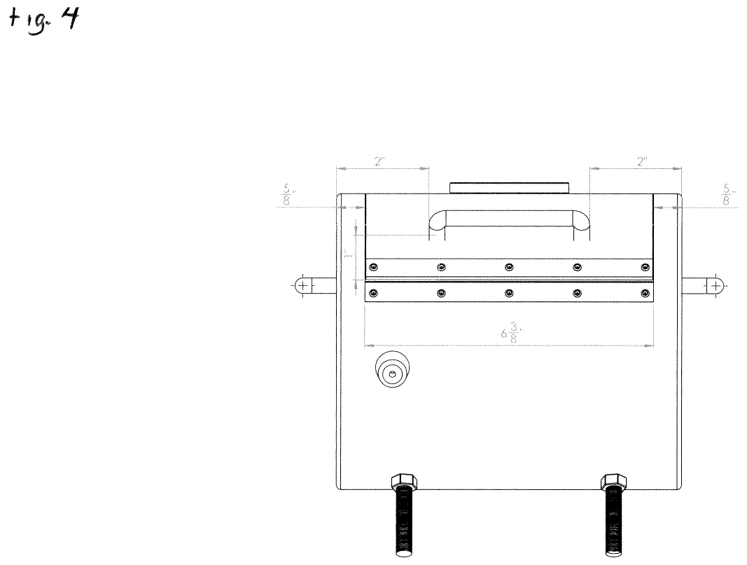

FIG. 5 DW-005 Bottom view with handles on left-right sides and stands-legs screws.

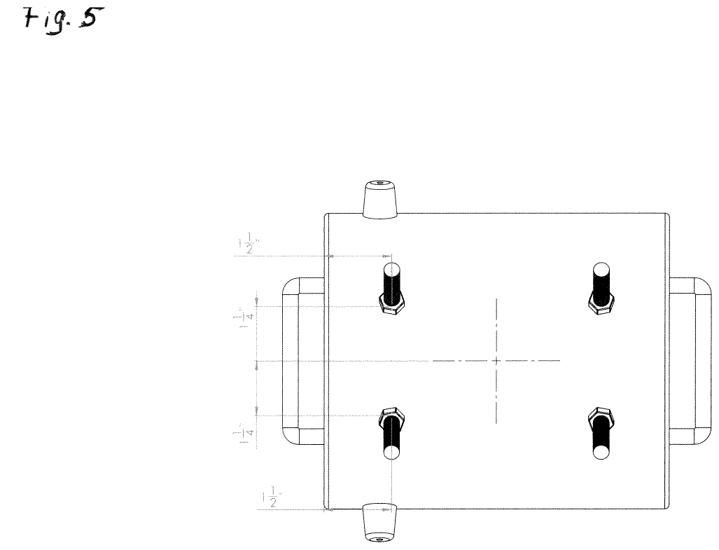

FIG. 6 DW-006 Ariel view with description of the herein above named figures/hardware.

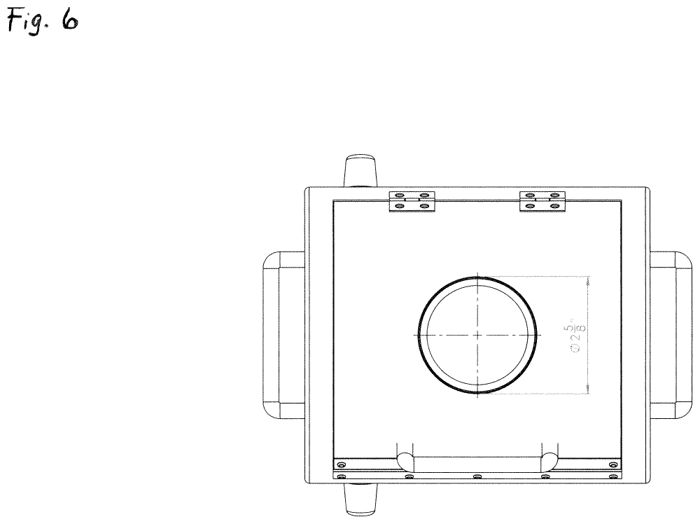

FIG. 7 DW-007 Left side view, stand-legs-screws, temp gauge on top, handles and smoke holes.

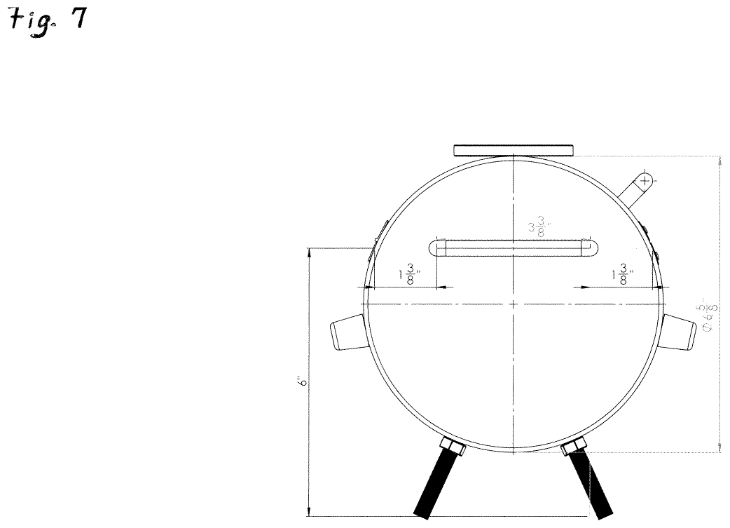

FIG. 8 DW-008 Metal heat plate soldered to bottom inside of paint can is used to balance and stabilize the aluminum foil Charcoal/Sterno tray from sliding and controlling the burn zone.

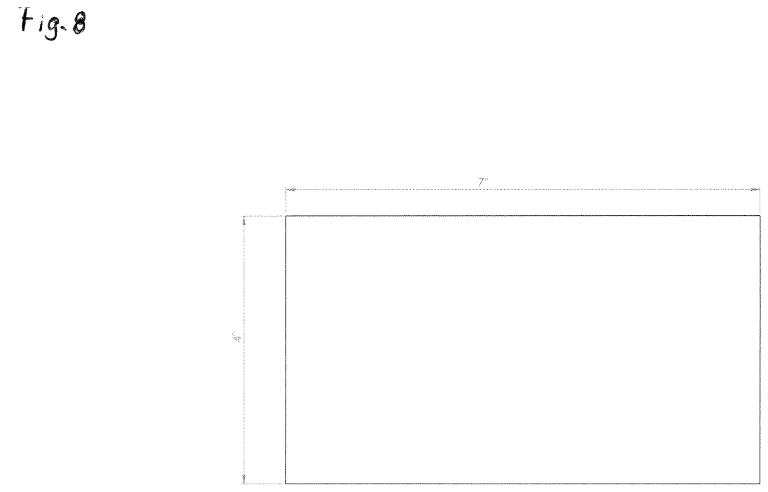

FIG. 9 DW-009 Disposable Aluminum foil Charcoal/Sterno tray.

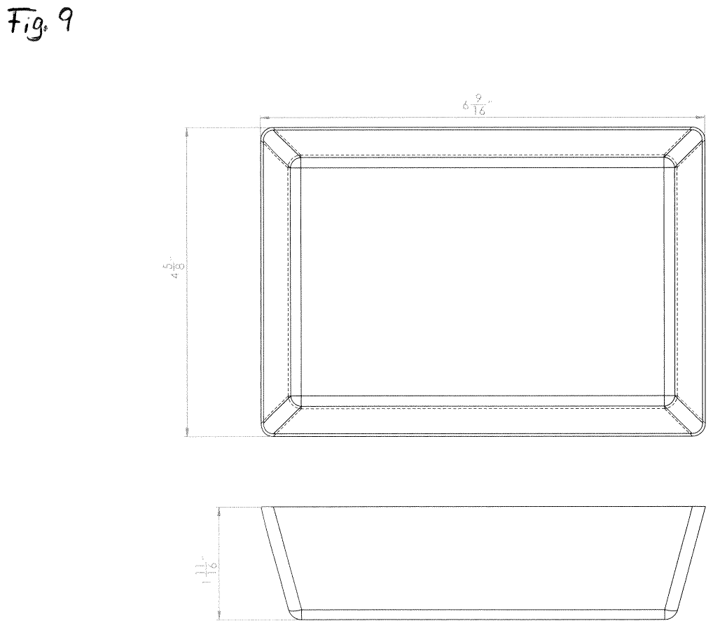

FIG. 10 DW-010 Grill for placing hamburger patty, hotdogs, small steak or cup of coffee or tea.

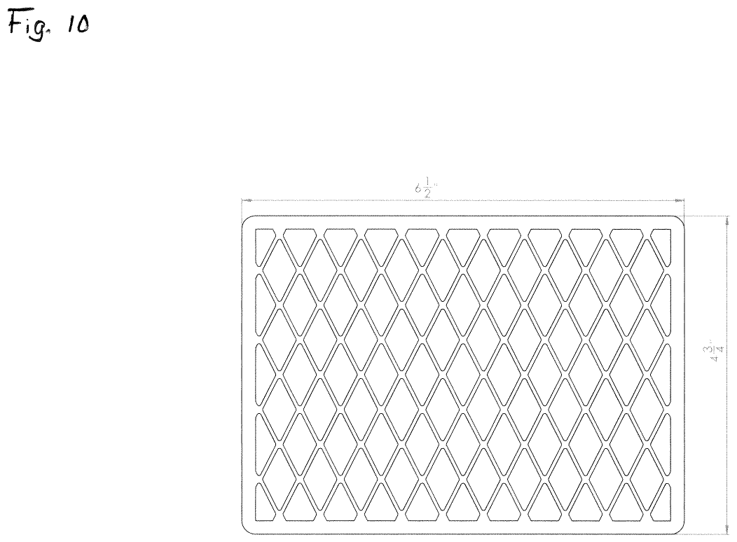

FIG. 11 DW-011 Corner braces to support and stabilize the grill from sliding and/or falling into the charcoal/sterno tray.

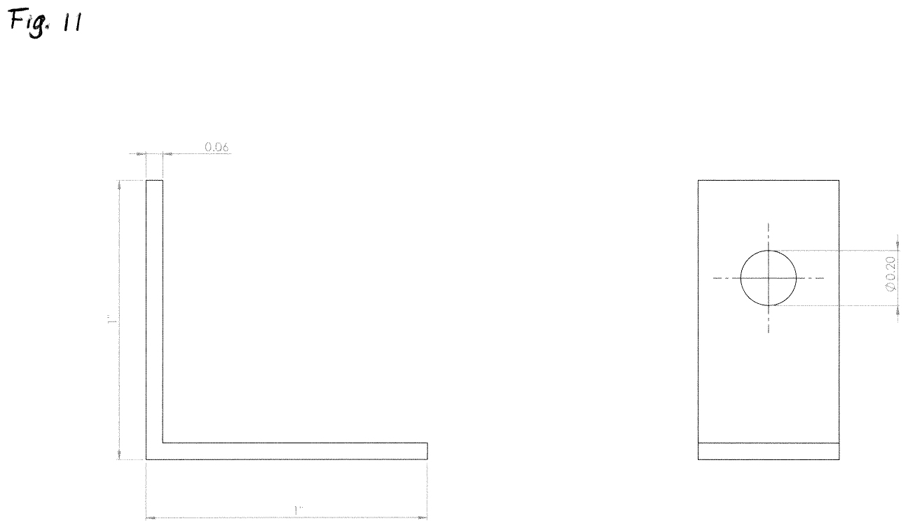

FIG. 12 DW-012 Grill-stand-legs to help prevent grill from tipping over.

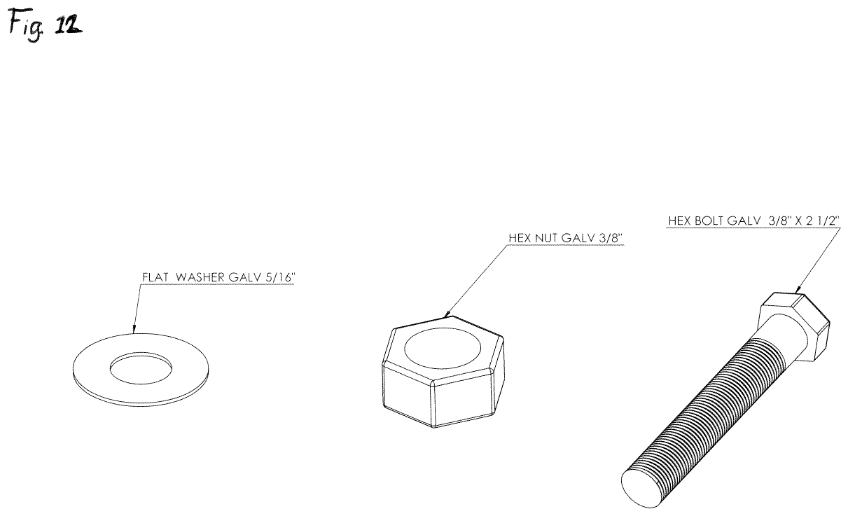

FIG. 13 DW-013 Hinges to open and close the BBQ grill lid.

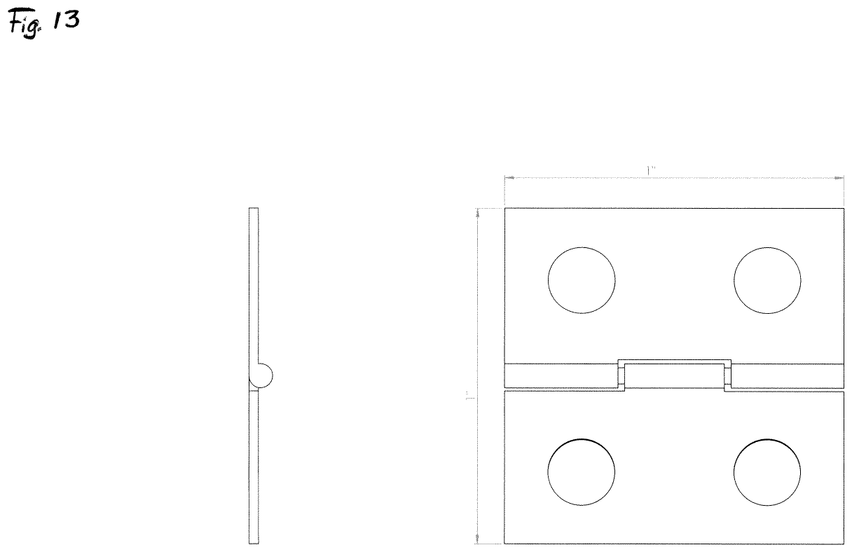

FIG. 14 DW-014 BBQ Grill lid handles to carry grill and/or open lid.

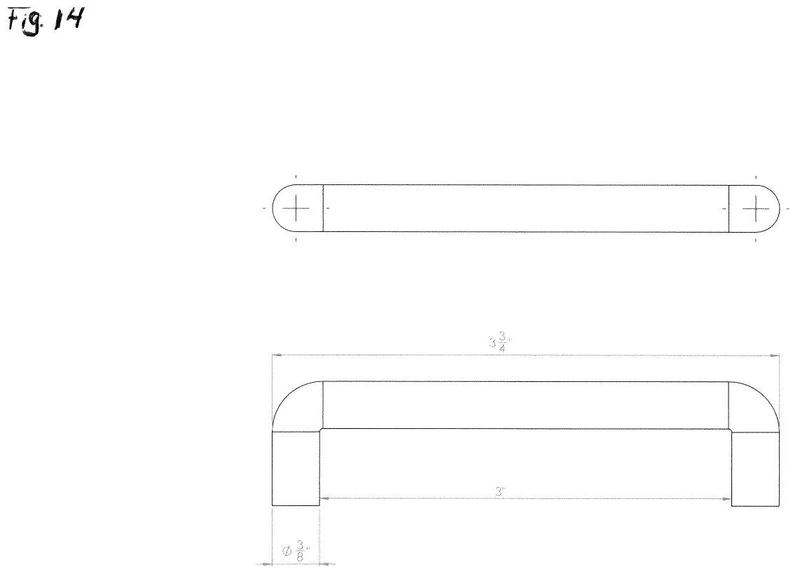

FIG. 15 DW-015 BBQ Grill lid used to cover meat and keep temperature at a reasonable degree.

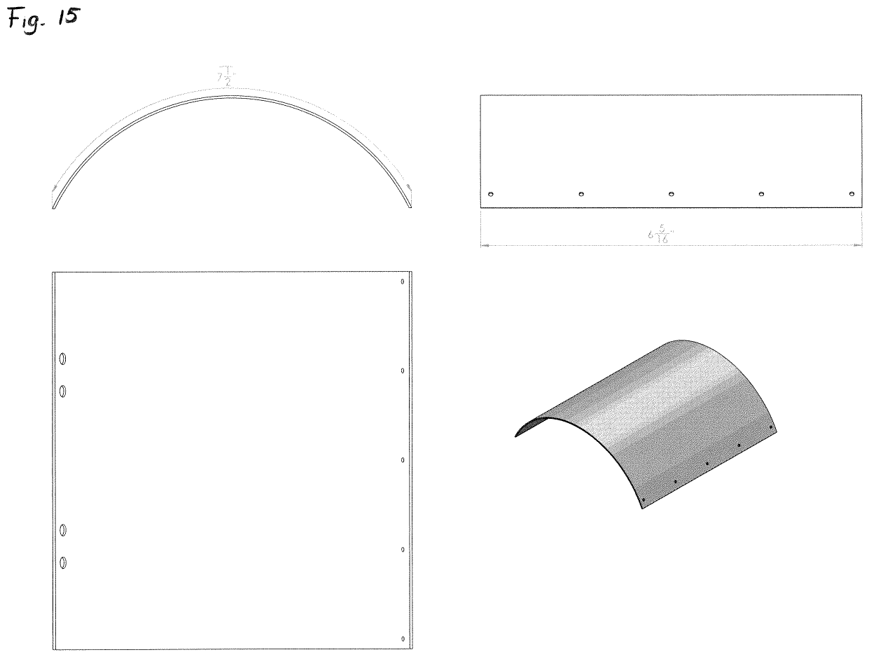

FIG. 16 DW-016 Temperature gauge used to regulate the heat and temperature of meat.

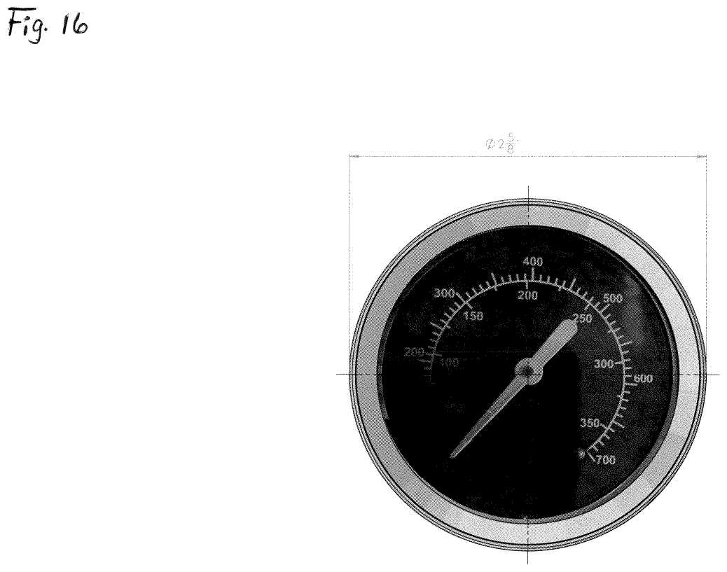

FIG. 17 DW-017 Disposable Sterno used to heat small cup of coffee or tea.

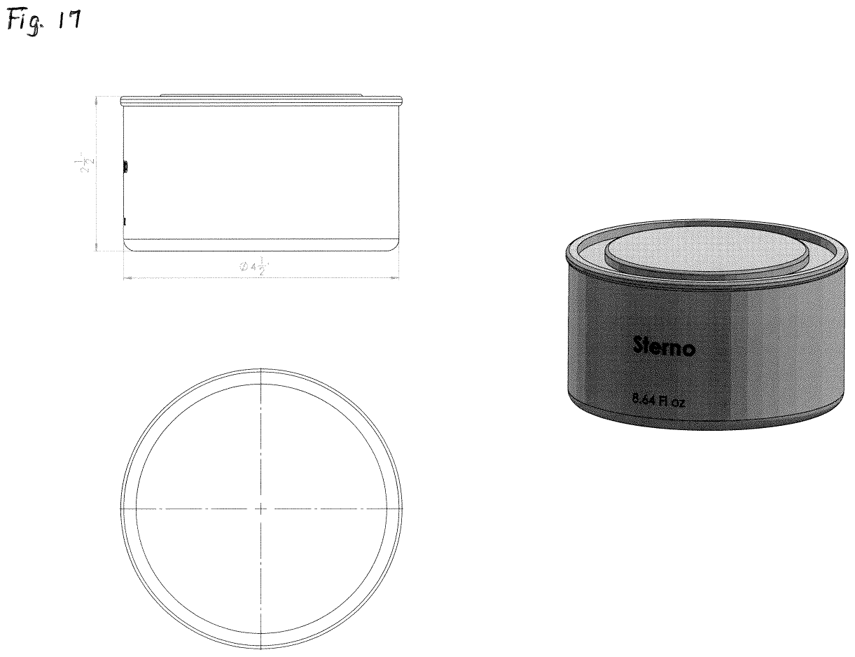

FIG. 18 DW-018 Section view—Left to right, front view and inside of BBQ for placement of corner braces, grill and charcoal/sterno tray.

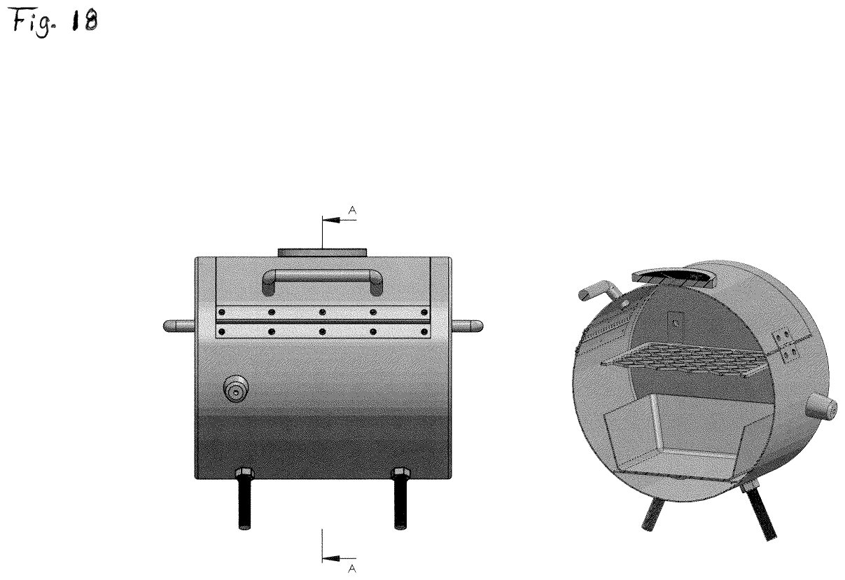

FIG. 19 DW-019 Exploded View of BBQ grill parts and placements of each.

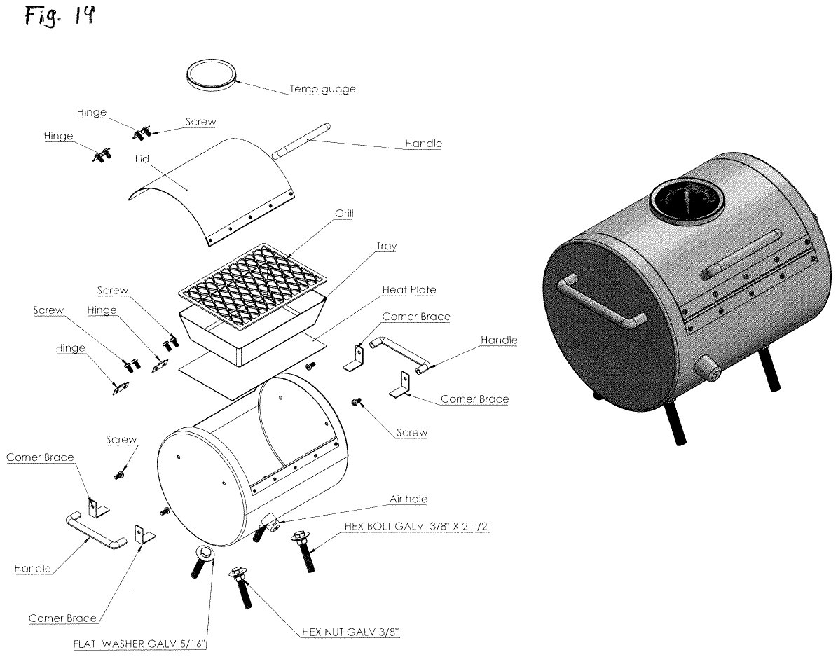

1. 1 gallon paint can as body and design of BBQ grill

2. 2 hinges with 4 screws a piece

3. 3 handles with 6 screws

4. 1 temperature gauge

5. 1 piece of sheet metal used a heat plate and to stabilize the charcoal/sterno tray

6. 1 disposable aluminum foil tray-pan for charcoal and Sterno

7. 1 metal grill made from paint pan/bucket grid

8. 4 corner braces with 2 screws a piece

9. 2 pieces of silver flashing with 10 rivets for front of lid

10. 4 Hex Bolts with 4 washers and nuts for legs-stand
